(19) United States
(12) Patent Application Publication
(10) Pub. No.: US 2016/0061997 A1
(43) Pub. Date: Mar. 3, 2016

(54) ANTIREFLECTIVE LAMINATE, POLARIZING PLATE, COVER GLASS, IMAGE DISPLAY DEVICE, AND METHOD OF MANUFACTURING ANTIREFLECTIVE LAMINATE

(71) Applicant: FUJIFILM Corporation, Tokyo (JP)

(72) Inventors: Kazuo KAMOHARA, Kanagawa (JP); Makoto UCHIMURA, Kanagawa (JP); Ayako MATSUMOTO, Kanagawa (JP)

(73) Assignee: FUJIFILM CORPORATION, Tokyo (JP)

(21) Appl. No.: 14/835,835

(22) Filed: Aug. 26, 2015

(30) Foreign Application Priority Data
Aug. 28, 2014 (JP) 2014-174541
Mar. 12, 2015 (JP) 2015-049924

(51) Int. Cl. G02B 1/118; G02B 1/14; G02B 5/30; G02B 1/111

(52) U.S. Cl. CPC G02B 1/118; G02B 1/111; G02B 1/14; G02B 5/3033

(57) ABSTRACT

There is provided an antireflective laminate including: a hard coat layer; and an antireflective layer adjacent to the hard coat layer, wherein the hard coat layer includes cellulose acylate in a region within 1 μm far from an interface with the antireflective layer in a film thickness direction, and the antireflective layer includes a binder resin and particles having an average primary particle diameter of 50 nm or more and 700 nm or less, and has a moth-eye structure by the particles on a surface opposite to the interface with the hard coat layer.

### CROSS REFERENCE TO RELATED APPLICATION(S)

This application claims priority from Japanese Patent Application Nos. 2014-174541 filed on Aug. 28, 2014, and 2015-049924 filed on Mar. 12, 2015, the entire disclosures of which are incorporated herein by reference.

### BACKGROUND

1. Technical Field

The present invention relates to an antireflective laminate, a polarizing plate, a cover glass, an image display device, and a method of manufacturing an antireflective laminate.

2. Background Art

In an image display device such as a cathode ray tube display (CRT), a plasma display (PDP), an electroluminescence display (ELD), a fluorescent display (VFD), a field emission display (FED), and a liquid crystal display (LCD), an antireflective film is provided in order to prevent contrast reduction or glare of the image due to the reflection of external lights on the surface of the display.

As the antireflective film, an antireflective film has been known, which includes, on a substrate surface, an antireflective layer having a fine unevenness shape in which a period is shorter than the wavelength of the visible light, that is, an antireflective having a so-called moth-eye structure. By the moth-eye structure, a refractive index gradient layer whose refractive index is changed continuously from the air towards a bulk material inside the substrate is artificially produced, so that reflection of light may be prevented.

As an antireflective film having the moth-eye structure, Japanese Patent Laid-Open Publication No. 2009-139796 (hereinafter JP-A-2009-139796) discloses an antireflective layer having a moth-eye structure formed by coating a coating liquid containing a transparent resin monomer and fine particles on a transparent substrate, curing the coating liquid to form a transparent resin dispersed with the fine particles, and then, etching the transparent resin.

Further, although there is no mention about the moth-eye structure, Japanese Patent Laid-Open Publication No. 2011-133842 discloses an anti-reflective laminate having a cured film containing a matrix having a specific polar group and particles on a substrate, in which the particles are unevenly distributed on a surface opposite to a surface in contact with the substrate in the cured film.

However, in the technique of JP-A-2009-139796, since it is necessary to etch a transparent resin, the manufacturing process of the antireflective film may become complicated.

An object of the present invention is to provide an antireflective laminate having a moth-eye structure, which has good antireflection performance and excellent surface uniformity and may be manufactured by a simple method. Further, another object of the present invention is to provide a polarizing plate, cover glass, and an image display device including the antireflective laminate. Further, still another object of the present invention is to provide a method of manufacturing the antireflective laminate.

In order to solve the above-mentioned problems, the present inventors have studied formation of a moth-eye structure by coating an antireflective layer forming composition containing particles and a binder resin forming compound. Further, it has been found that, in the coating step, when a content of the particles are low and the coating liquid is coated while the particles are not aggregated, some of the binder forming compound permeates into a lower layer so that the content of the binder forming compound in the antireflective layer is reduced, and when the antireflective layer is completed, a fine unevenness formed by some of the particles protruding from the surface of the film, functions as a moth-eye structure. Further, it has been found that, if cellulose acylate is present near the surface of the lower layer when the antireflective layer forming composition, the binder forming compound is easy to permeate, and an antireflective laminate excellent in surface uniformity with low reflectivity may be easily manufactured.

That is, the present invention has the following configuration.

### SUMMARY

[1] An antireflective laminate including: a hard coat layer; and an antireflective layer adjacent to the hard coat layer, wherein the hard coat layer includes cellulose acylate in a region within 1 μm far from an interface with the antireflective layer in a film thickness direction, and the antireflective layer includes a binder resin and particles having an average primary particle diameter of 50 nm or more and 700 nm or less, and has a moth-eye structure by the particles on a surface opposite to the interface with the hard coat layer.

[2] The antireflective laminate according to [1], wherein the hard coat layer includes a cured product of a polyfunctional monomer containing three or more (meth)acryloyl groups in one molecule.

[3] The antireflective laminate according to [1] or [2], wherein the hard coat layer includes a product formed by reacting an additive having a hydroxyl group-reactive moiety and a hydroxyl group contained in the cellulose acylate.

[4] The antireflective laminate according to [3], wherein the additive is an additive having two or more hydroxyl group-reactive moieties, or an additive having one or more hydroxyl group-reactive moieties and a polymerizable group-reactive moiety.

[5] An antireflective laminate including, on a substrate, the antireflective laminate according to any one of [1] to [4], wherein the hard coat layer is provided at a substrate side than the antireflective laminate.

[6] The antireflective laminate according to [5], wherein the substrate is a plastic substrate.

[7] The antireflective laminate according to [6], wherein the plastic substrate is a cellulose acylate film.

[⁸] A method of manufacturing the antireflective laminate, including:

coating, on a cellulose acylate film, a hard coat forming composition containing a binder resin forming compound and a solvent having a permeability to cellulose acylate to cause the binder resin forming compound to permeate into the cellulose acylate film;

curing the binder resin forming compound to form a hard coat layer; and

coating, on the hard coat layer, an antireflective layer forming composition containing particles having an average primary particle diameter of 50 nm to 700 nm, a binder resin forming compound, and a solvent so that a part of the binder resin forming compound is permeated into the hard coat layer to protrude the particles and form a moth-eye structure due to the particles on a surface opposite to an interface with the hard coat layer.

[9] The method according to [8], wherein the binder resin forming compound is a compound having a polymerizable group, and a reaction ratio of the polymerizable group of the compound having the polymerizable group is 20% to 75% at the surface of the hard coat layer before the antireflective layer forming composition is coated.

[10] A polarizing plate including the antireflective laminate according to any one of [1] to [7].

[11] A cover glass including the antireflective laminate according to any one of [1] to [7].

[12] An image display device including the antireflective laminate according to any one of [1] to [7].

[13] An image display device including the cover glass according to [10].

According to the present invention, it is possible to provide an antireflective laminate having a moth-eye structure, which has good antireflection performance and excellent surface uniformity and may be manufactured by a simple method. Further, according to the present invention, it is possible to provide a polarizing plate, cover glass, and an image display device including the antireflective laminate. Furthermore, according to the present invention, it is possible to provide a method of manufacturing the antireflective laminate.

### BRIEF DESCRIPTION OF DRAWINGS

FIG. 1 is a schematic view illustrating an exemplary antireflective laminate of the present invention.

FIG. 2 is a schematic view illustrating another exemplary antireflective laminate of the present invention.

FIG. 3 is a schematic view illustrating still another exemplary antireflective laminate of the present invention.

### DETAILED DESCRIPTION OF EXEMPLARY EMBODIMENTS

An antireflective laminate of the present invention is an antireflective laminate including a hard coat layer and an antireflective layer which are adjacent to each other, in which the hard coat layer includes cellulose acylate in a region within 1 μm far from the interface with the antireflective layer in a film thickness direction, and the antireflective layer includes particles having an average primary particle diameter of 50 nm to 700 nm and a binder resin, and has a moth-eye structure by the particles on a surface opposite to the interface with the hard coat layer.

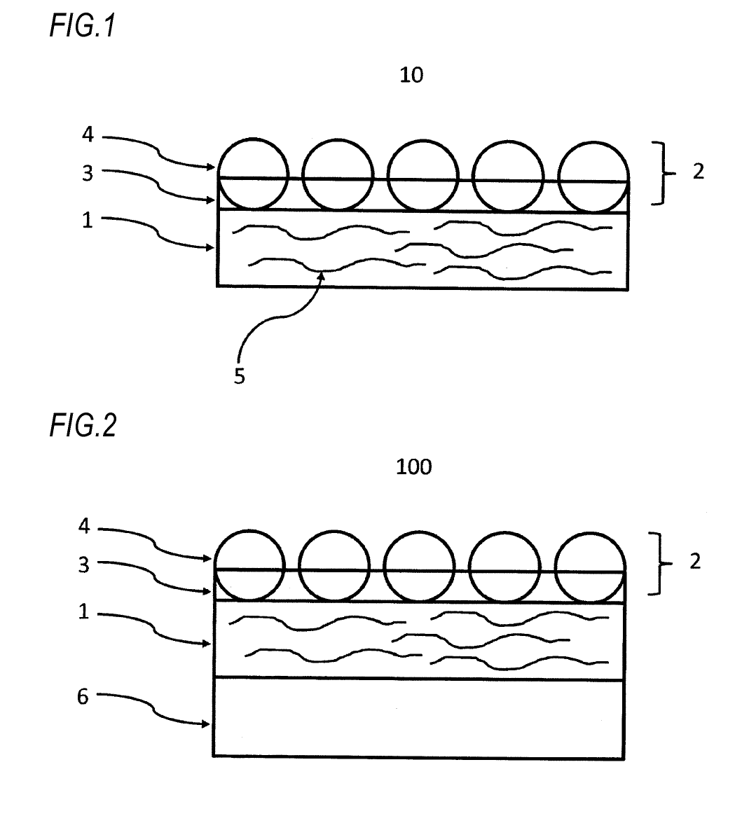

FIG. 1 is a schematic view illustrating an exemplary antireflective laminate of the present invention.

An antireflective laminate 10 of FIG. 1 includes a hard coat layer 1 and an antireflective layer 2 which are adjacent to each other. The hard coat layer 1 includes cellulose acylate 5 in a region within 1 μm far from the interface with the antireflective layer 2 in a film thickness direction. The antireflective layer 2 includes particles 4 having an average primary particle diameter of 50 nm to 700 nm and a binder resin 3, and has a moth-eye structure by the particles 4 on a surface opposite to the interface with the hard coat layer 1.

Further, the antireflective laminate of the present invention may be provided on a substrate, or may be an antireflective laminate in which the hard coat layer is disposed at the substrate side. The substrate is preferably a plastic substrate, and more preferably cellulose acylate film. When the substrate is in a film shape, the antireflective laminate may be used as an antireflective film.

FIG. 2 is a schematic view illustrating another exemplary antireflective laminate of the present invention.

An antireflective laminate 100 of FIG. 2 is formed by laminating the antireflective laminate illustrated in FIG. 1 and the substrate 6. In the antireflective laminate 100, the substrate 6 is adjacent to a surface in contact with the antireflective layer of the hard coat layer 1.

Further, as described later, a product formed by reacting an additive having a hydroxyl group-reactive moiety and a hydroxyl group contained the cellulose acylate, is preferably included in the hard coat layer. Accordingly, scratch resistance of the antireflective layer may be enhanced.

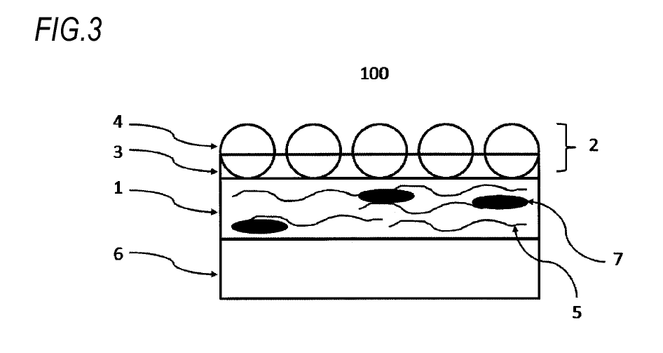

FIG. 3 is a schematic view illustrating still another exemplary antireflective laminate of the present invention.

An antireflective laminate 100 includes a product formed by reacting, in the hard coat layer 1, the additive 7 having a hydroxyl group-reactive moiety and a hydroxyl group contained the cellulose acylate, as illustrated in FIG. 2. The product has a structure in which the cellulose acylate 5 and the additive 7 are linked by a covalent bond.

In the hard coat layer of the antireflective laminate, fact that the hard coat layer includes cellulose acylate in a region within 1 μm far from the interface with the antireflective layer in a film thickness direction, may be confirmed by a peak at 903 cm⁻¹ in a single reflective ATR-IR measurement, and the content of the cellulose acylate may be determined by the height of the peak.

Further, the distribution of the cellulose acylate in the film thickness direction, which is included in the hard coat layer, may be determined by a TOF-SIMS measurement after diagonal cross-sectional cutting.

From the viewpoint of pencil hardness, it is preferred that the distribution of the cellulose in the hard coat in the film thickness direction is not uniform and the amount of the cellulose acylate included in the interface of the hard coat layer with the antireflective layer is less than the amount of the cellulose acylate included in the interface of the hard coat layer with a side opposite to the antireflective layer (the substrate side).

Meanwhile, when the film thickness of the hard coat layer is less than 1 μm, in the same manner as described above, it is possible to confirm whether the cellulose acylate is included in the film thickness direction from the interface of the hard coat layer with the antireflective layer, or its distribution, by performing a measurement at an incident angle of 60° using Ge by a multiple reflection measurement in an ATR-IR measurement.

[Hard Coat Layer]

In the present invention, the hard coat layer refers to a layer (region) including cellulose acylate and a cured product of an ionizing radiation-curable compound.

The hard coat layer includes cellulose acylate, and is preferably formed by a crosslinking reaction or polymerization of a curable compound which is a compound having a polymerizable group (preferably, ionizing radiation-curable compound). For example, the hard coat layer may be formed by coating a coating composition containing an ionizing radiation-curable polyfunctional monomer or polyfunctional oligomer.

A functional group (polymerizable group) of the ionizing radiation-curable polyfunctional monomer or polyfunctional oligomer is preferably photo-, electron beam-, or radiation-polymerizable. Among them, a photopolymerizable functional group is preferred.

Examples of the photopolymerizable functional group may include an unsaturated polymerizable functional group such as a (meth)acryloyl group, a vinyl group, a styryl group, and an allyl group. Among those, a (meth)acryloyl group is preferred.

Specific examples of the compound having a polymerizable unsaturated group may include (meth)acrylate diesters of alkylene glycol such as neopentyl glycol acrylate, 1,6-hexanediol (meth)acrylate, and propylene glycol di(meth)acrylate; (meth)acrylate diesters of polyoxyalkylene glycol such as triethylene glycol di(meth)acrylate, dipropylene glycol di(meth)acrylate, polyethylene glycol di(meth)acrylate, and polypropylene glycol di(meth)acrylate; (meth)acrylate diesters of polyhydric alcohol such as pentaerythritol di(meth)acrylate; and (meth)acrylate diesters of an ethylene oxide or propylene oxide adduct such as 2,2-bis {4-(acryloxydiethoxy)phenyl}propane, and 2-2-bis {4-(acryloxypolypropoxy)phenyl}propane.

Furthermore, epoxy (meth)acrylates, urethane (meth)acrylates, or polyester (meth)acrylates are also preferably used as the photopolymerizable polyfunctional monomer.

Among those, esters of polyhydric alcohol and (meth)acrylate are preferred. More preferably, a polyfunctional monomer having three or more (meth)acryloyl groups in one molecule is preferred. That is, the hard coat layer preferably contains a cured product of the polyfunctional monomer having three or more (meth)acryloyl groups in one molecule.

Examples thereof may include pentaerythritol tetra (meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphate tri(meth)acrylate, trimethylolethane tri(meth)acrylate, ditrimethylolpropane tetra(meth)acrylate, dipentaerythritol tetra(meth)acrylate, dipentaerythritol pental(meth)acrylate, dipentaerythritol hexa(meth)acrylate, pentaerythritol hexa(meth)acrylate, 1,2,3-chlorohexane tetramethacrylate, polyurethane polyacrylate, polyester polyacrylate, and caprolactone-modified tris(acryloxyethyl)isocyanurate.

Specific examples of the polyfunctional acrylate-based compound having a (meth)acryloyl group may include an esterified product of polyol and (meth)acrylate such as KAYARAD DPHA, DPHA-2C, PET-30, TMPTA, TPA-320, TPA-330, RP-1040, T-1420, D-310, DPCA-20, DPCA-30, DPCA-60, GPO-303 manufactured by Nippon Kayaku Co., Ltd., and V#3PA, V#400, V#36095D, V#1000, V#1080 manufactured by OSAKA ORGANIC CHEMICAL INDUSTRY LTD. Further, tri- or higher-functional urethane acrylate compounds such as SHIKOH UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, and UV-2750B (manufactured by Nippon Synthetic Chemical Industry Co., Ltd.), UL-503LN (manufactured by KYOEISHA CHEMICAL Co., Ltd.), UNIDIC 17-806, 17-813, V-4030, and V-4000BA (manufactured by DIC Corporation), EB-1290K, EB-220, EB-5129, EB-1830, and EB-4858 (manufactured by Daicel-UCB Co. Ltd.), HI-COAP AU-2010, and AU-2020 (manufactured by TOKUSHIKI Co., Ltd.), ARONIX M-1960 (manufactured by TOAGOSEI CO., LTD.), ART RESIN UN-3320HA, UN-3320HC, UN-3320HS, and UN-904, HDP-4T, and tri- or higher polyfunctional polyester compounds such as ARONIX M-8100, M-8030, and M-9050 (manufactured by TOAGOSEI CO., LTD.), and KRM-8307 (manufactured by DAICEL-CYTEC Company Ltd.), may be suitably used. Particularly, DPHA or PET-30 is preferably used.

Further, examples thereof may also include a resin having three or more (meth)acryloyl groups, for example, a relatively low molecular weight polyester resin, polyether resin, acrylic resin, epoxy resin, urethane resin, alkyd resin, spiroacetal resin, polybutadiene resin, polythiolpolyene resin, and a oligomer or prepolymer of a polyfunctional compound such as polyhydric alcohol.

Further, a dendrimer described in Japanese Patent Laid-Open Publication Nos. 2005-76005 and 2005-36105, or a nobornene ring-containing monomer described in Japanese Patent Laid-Open Publication No. 2005-60425, may be used.

The polyfunctional monomer may be used in combination of two or more kinds thereof. Polymerization of the monomer having an ethylenically unsaturated group may be performed by irradiation with ionizing radiation or heating in the presence of a photo-radical initiator or a thermal-radical initiator.

The polyfunctional monomer is preferably a compound having a molecular weight of 150 to 1600.

Further, the polyfunctional monomer is preferably a compound having an SP value of 20 to 25.

Meanwhile, the SP value (solubility parameter) is a value calculated by Hoy's method, and the Hoy's method is described in POLYMER HANDBOOK FOURTH EDITION.

The film thickness of the hard coat layer is generally about 0.6 μm to 50 μm, and preferably 5 μm to 20 μm from the viewpoint of imparting sufficient durability and impact resistance to the film.

Further, the hardness of the hard coat layer is preferably H or higher, and more preferably 2H or higher as measured by a pencil hardness test. Further, in Taber test in accordance with JIS K5400, smaller abrasion loss of a test piece after the test is preferred.

In the present invention, the hard coat layer includes cellulose acylate in a region within 1 μm far from the interface with the antireflective layer in the film thickness direction.

As the cellulose acylate, a substrate described in [0072] to [0084] of Japanese Patent Laid-Open Publication No. 2012-093723 may be preferably used.

The hard coat layer including cellulose acylate in a region within 1 μm far from the interface with the antireflective layer in the film thickness direction, may be formed, for example, by coating, onto a substrate containing cellulose acylate (cellulose acylate film or the like), a hard coat layer forming composition containing a solvent having a permeability to the substrate and a curable compound to cause the curable compound to permeate into the substrate, and curing the compound. Further, the hard coat may be formed by mixing the cellulose acylate and the curing compound and curing the mixture.

The hard coat layer may be measured as a region where cellulose acylate and a cured product of an ionizing radiation-curable compound are detected when the antireflective laminate is cut by a microtome and the cross-section thereof is analyzed by a time-of-flight secondary ion mass spectrometry, and the film thickness of the region may also be measured from the cross-sectional information of the TOF-SIMS.

Further, hard coat layer may also be measured, for example, by detecting an additional layer in the middle of the substrate and the antireflective layer by cross-sectional observation with a reflective spectroscopic film thickness meter using interference of light or a transmission electron microscope (TEM). As the reflective film thickness monitor, FE-3000 (manufactured by OTSUKA ELECTRONICS Co., LTD.) may be used.

The thickness of the hard coat layer is preferably 5 μm to 20 μm from the viewpoint of the pencil hardness and curl.

In the present invention, preferred is a method in which, when the antireflective layer is laminated on the hard coat layer, the hard coat layer is half-cured in advance so as to cause the binder forming compound in the antireflective layer to permeate into the hard coat layer, and after the binder forming compound permeate therein, the hard coat layer is full-cured.

Further, as described later, it is preferred that a binder resin or the binder resin forming compound in the reflective layer is included in the hard coat layer.

(Solvent Having Permeability to Cellulose Acylate)

The hard coat layer forming composition preferably contains a solvent having a permeability to cellulose acylate (hereinafter, also referred to as a “permeable solvent”).

The solvent having a permeability to cellulose acylate refers to a solvent having a dissolvability and a swellability with respect to the surface of the substrate containing cellulose acylate (cellulose acylate substrate).

Here, in the present invention, the solvent having a dissolvability with respect to a cellulose acylate substrate means a solvent in which a peak area of cellulose acylate is 400 mV/sec or more as measured by immersing a 24 mm×36 mm (thickness 80 μm) cellulose acylate substrate in a 15 ml bottle containing the solvent at room temperature (25° C.) for 60 seconds and then analyzing the immersed solution by Gel Permeation Chromatography (GPC). Or, it is also referred to as a solvent having a dissolvability with respect to a cellulose acylate substrate when a 24 mm×36 mm (thickness 80 μm) cellulose acylate substrate is maintained in a 15 ml bottle containing the solvent at room temperature (25° C.) for 24 hours, and then, the bottle appropriately shakes so that the cellulose acylate is completely dissolved, thereby losing its form.

As the permeable solvent, methyl ethyl ketone (MEK), dimethyl carbonate, methyl acetate, acetone, and methylene chloride may be preferably used without being limited thereto. More preferred are methyl ethyl ketone (MEK), dimethyl carbonate, and methyl acetate.

The hard coat layer forming composition may contain a solvent (for example, isopropanol (IPA), methyl isobutyl ketone (MIBK), toluene, and the like) other than the permeable solvent.

In the hard coat layer forming composition, the content of the permeable solvent is preferably 70% by mass to 100% by mass, and more preferably 83% by mass to 100% by mass based on the mass of the whole solvent contained in the hard coat layer forming composition.

The solid concentration of the hard coat layer forming composition is preferably 20% by mass to 60% by mass, and more preferably 30% by mass to 50% by mass.

As the solid concentration decreases, the solvent amount in the hard coat layer forming composition increases. Therefore, the permeability into the substrate increases, which is preferable. However, if the solid concentration is too low, coating surface is deteriorated because the viscosity of the coating liquid is reduced, and therefore both of excellent permeability and surface property cannot be achieved.

(Additive Having Hydroxyl Group-Reactive Moiety)

The hard coat layer forming composition preferably contains an additive having a hydroxyl group-reactive moiety. Since the additive having a hydroxyl group-reactive moiety reacts with a hydroxyl group remaining in the cellulose acylate, the finished hard coat layer preferably includes a product formed by reaction of the additive having a hydroxyl group-reactive moiety and the hydroxyl group contained in the cellulose acylate.

Since the hydroxyl group remaining in the cellulose acylate and the additive react to form a crosslinking structure, it is possible to suppress elution of the cellulose acylate into the antireflective layer, thereby enhancing a scratch resistance of the antireflective layer.

When the additive having a hydroxyl group-reactive moiety is contained, the content thereof is preferably 3% by mass to 40% by mass, and more preferably 5% by mass to 20% by mass in the solid of the hard coat layer forming composition. If the content of the additive is 3% by mass or more in the solid of the hard coat layer forming composition, the elution of the cellulose acylate may be effectively suppressed. If the content is 40% by mass or less, the hardness of the hard coat layer may be maintained sufficiently high.

Examples of the hydroxyl group-reactive moiety (functional group) may include a hydroxyl group, a formyl group, an isocyanate group, a thioisocyanate group, a carboxyl group, a chlorocarboxyl group, an acid anhydride group, a sulfonate group, a chlorosulfonate group, a sulfinate group, a chlorosulfinyl group, an epoxy group, a vinyl group, and a halogen atom. Preferred are an epoxy group, a hydroxyl group, a formyl group, an isocyanate group, a blocked isocyanate group, a thioisocyanate group, and a carboxyl group, and more preferred are an epoxy group and a blocked isocyanate group.

When the reaction of the functional group contained in the additive and the hydroxyl group remaining in the cellulose acylate occurs during the formation of the hard coat layer, the binder forming compound is difficult to permeate during the formation of the antireflective layer. Therefore, it is preferred that the reaction occurs by a heating processing during the antireflective layer. Accordingly, it is considered that the blocked isocyanate whose blocking group is left by heating and react, or the epoxy group which reacts using a heat-cationic polymerization agent during heating is preferred.

The additive is preferably an additive having at least one hydroxyl group-reactive moiety, and more preferably an additive having at least two hydroxyl group-reactive moieties.

The additive may be used either alone or in combination of two or more thereof.

Examples of the compound having a functional group which may react with a hydroxyl group may include Desmodur H, Desmodur I, Desmodur W, Sumidur 44 S, Desmodur L 75(C), Desmodur IL 1451 BA, Desmodur BL 1100/1, Desmodur BL 3575/1 MPA/SN, Desmodur BL 4265 SN, Desmodur BL 5375 MPA/SN, and Desmodur VP LS 2078/2, manufactured by Sumitomo Bayer Urethane Co., Ltd., but not limited thereto.

Further, the additive is also preferably an additive having at least one hydroxyl group-reactive moiety and a polymerizable group-reactive moiety.

A crosslinking structure may be formed by first reacting the compound with a hydroxyl group remaining in the cellulose acylate and then reacting the polymerizable group contained in the compound with a compound having a polymerizable unsaturated group contained in the hard coat layer forming composition.

The functional group which may react with a hydroxyl group remaining in the cellulose acylate is the same as those described above.

Examples of the polymerizable group may include a styryl group, an allyl group, a vinylbenzyl group, a vinyl ether group, a vinyl ketone group, vinyl group, an isopropenyl group, an isopropenyl group, an acryloyl group, a methacryloyl group, a glycidyl group, and an epoxy group. Preferred is a methacryloyl group or acryloyl group.

Examples of the additive having at least one hydroxyl group-reactive moiety and a polymerizable group-reactive moiety may include Karenz MOI, Karenz AOI, Karenz MOI-BM, Karenz MOI-BP, Karenz BEI, and Karenz MOI-EG manufactured by SHOWA DENKO K.K., or CYCLOMER M100 and CELLOXIDE 2000 manufactured by Daicel Corporation, but not limited thereto.

(Other Components)

In addition to the above-mentioned components, a polymerization initiator, an antistatic agent, and an anti-glare agent may be further added appropriately to the hard coat layer forming composition. Further, various additives such as a reactive or unreactive leveling agent and various sensitizers may be mixed therein.

(Polymerization Initiator)

Radical and cationic polymerization agents may be appropriately selected and used as necessary. These polymerization initiators are decomposed by light irradiation and/or heating to generate radical or cation, which progress polymerization.

(Antistatic Agent)

Specific examples of the antistatic agent may include a conventionally known antistatic agent such as a quaternary ammonium salt, a conductive polymer, and conductive particles.

(Refractive Index Adjusting Agent)

In order to control the refractive index of the hard coat layer, a high-refractive index monomer or inorganic particles may be added as a refractive index adjusting agent. In addition to the effect of controlling the refractive index, the inorganic particles have an effect of suppressing curing shrinkage by a crosslinking reaction. In the present invention, a polymer, including inorganic particles dispersed therein, formed by polymerization of the polyfunctional monomer and/or the high-refractive index monomer after the formation of the hard coat layer, is referred to as a binder.

(Leveling Agent)

Specific examples of the leveling agent may include a conventionally known leveling agent such as a fluorine- or silicon-based leveling agent. The hard coat layer which is added with the leveling agent may impart a coating stability to the surface of the coating film during coating or drying.

[Antireflective Layer]

The antireflective laminate of the present invention has an antireflective layer adjacent to the hard coat layer.

The antireflective layer includes particles having an average primary particle diameter of 50 nm to 700 nm and a binder resin.

The surface of the antireflective layer opposite to the interface with the hard coat layer has a moth-eye structure.

Here, the moth-eye structure is a processed surface of substance (material) for suppressing reflection of light, and refers to a structure having a periodic microstructured pattern. Particularly, for the purpose of suppressing reflection of visible light, the moth-eye structure refers to a structure having a microstructured pattern with a period less than 780 nm. When the period of the microstructured pattern is less than 380 nm, it is preferred in that the coloring of the reflected light disappears. Further, when the period is 100 nm or more, the microstructured pattern may be recognized by light with a wavelength of 380 nm. Therefore, it is preferred in that the antireflection is excellent. The presence of the moth-eye structure may be confirmed by observing the surface shape with a scanning electron microscope (SEM) or an atomic force microscope (AFM) and examining whether the microstructured pattern is formed.

In the present invention, the moth-eye structure may be preferably prepared as follows.

An antireflective layer forming composition containing particles, a binder resin forming compound, and a solvent is coated on the surface of the hard coat layer formed on a substrate to cause a part of the binder resin forming compound to permeate into the hard coat layer such that the particles protrude, thereby forming an unevenness structure (moth-eye structure) by the particles. In the present invention, since cellulose acylate is present near the surface of the hard coat layer when the antireflective layer forming composition is coated, the binder resin forming compound is easy to permeate.

The height of a convex portion of the moth-eye structure may be controlled by a volume ratio of the binder resin and the particles in the antireflective layer after curing. Therefore, it is important to appropriately set a mixing ratio of the binder resin and the particles. Furthermore, in order to reduce the reflectivity by increasing the height of the convex portion, it is preferred that the particles forming the convex portion are filled evenly with a high filling rate. Further, it is also important that the filling rate is not too high. If the filling rate is too high, the adjacent particles may come into contact with each other, so that the height of the unevenness structure is reduced. From the above-mentioned viewpoint, it is preferred that the content of the particles forming the convex portion is adjusted to be uniform through the whole antireflective layer. The filling rate may be measured as an area occupancy rate of the particles located closest to the surface side when the particles forming the convex portion from the surface, by SEM, and is preferably 30% to 95%, more preferably 40 to 90%, and still more preferably 50 to 85%.

The film thickness of the antireflective layer is preferably 0.05 μm to 5 μm, and more preferably 0.1 μm to 1 μm.

In present invention, the antireflective layer is a layer (region) including the particles and the binder resin. The interface between the antireflective layer and the hard coat layer refers to a surface with which the particles in the antireflective layer are in contact.

(Particles Having Average Primary Particle Diameter of 50 nm to 700 nm)

Descriptions will be made on particles having an average primary particle diameter of 50 nm to 700 nm, which are included in the antireflective layer.

Examples of the particles may include metal oxide particles, resin particles, and organic inorganic hybrid particles having a metal oxide particle core and a resin shell. However, metal oxide particles are preferred from the viewpoint of excellent film strength.

Examples of the metal oxide particles may include silica particles, titania particles, zirconia particles, and antimony pentaoxide particles. However, silica particles are preferred from the viewpoint that their refractive index is close to those of many binders, so that haze hardly occurs and the moth-eye structure is easily formed.

Examples of the resin particles may include poly methyl methacrylate particles, polystyrene particles, and melamine particles.

The average primary particle diameter of the particles is 50 nm to 700 nm, preferably 100 urn to 650 nm, more preferably 150 nm to 530 nm, and still more preferably 200 nm to 380 nm from the viewpoint that the particles can form the moth-eye structure side by side. When the particle diameter is equal to or higher than the lower limit, it is possible to enhance the antireflection effect of visible light. When the particle diameter is equal to or lower than the upper limit, the particles do not act as scatters and, the antireflection effect of visible light is also excellent in this case.

It is possible to use two or more kinds of particles having different average primary particle diameter.

The average primary particle diameter of the particles refers to a 50% accumulative particle diameter of a volume average particle diameter. When the average primary particle diameter of the particles included in the antireflective layer is measured, the measurement may be performed by an electron microscope. For example, a sectioned TEM image of the antireflective image is photographed to measure diameters of 100 primary particles, and the volume is calculated to obtain a 50% accumulative particle diameter as the average primary particle diameter. When a particle does not have a spherical diameter, an average of the major diameter and the minor diameter thereof is considered as a diameter of the primary particle.

The shape of the particles is most preferably spherical, but may be amorphous other than spherical.

Further, the silica particles may be either crystalline or amorphous.

The particles may be subjected to a surface treatment in order to enhance the dispersibility in the antireflective layer forming composition, enhance the film strength, and prevent aggregation. Specifically, from the viewpoint of enhancing the film strength, particles whose surface is subjected to a treatment by a compound having an unsaturated double bond, are preferred. Specific examples of the surface treatment and preferred examples thereof are the same as those described in [0119] to [0147] of Japanese Patent Laid-Open Publication No. 2007-298974.

Further, in order to impart antifouling property to the antireflective layer having the moth-eye structure, the particles may be subjected to a water- and oil-repellency treatment on its surface. When used in combination with a case of adding an antifouling agent to the antireflective layer, as described later, it is more preferred in that the antifouling property is maintained even when dirt is repeatedly attached. As the water repellent treatment and oil repellent treatment, it is preferred to perform a dry or wet treatment using fluorine-containing alkoxysilane or alkoxysilane having a polydimethylsiloxane unit in its molecule.

Examples of the fluorine-containing alkoxysilane may include KP-801M (manufactured by Shin-Etsu Chemical Co., Ltd.) which is a fluoroalkyl group-containing oligomer, X-24-7890 (manufactured by Shin-Etsu Chemical Co., Ltd.), KBM-7803 (trifluoropropyltrimethoxysilane, manufactured by Shin-Etsu Chemical Co., Ltd.), SIH5841.5 (heptadecafluoro-1,1,2,2-tetrahydrodecyltrimethoxysilane, manufactured by Gelest), and SIH5841.2 (heptadecafluoro-1,1,2,2-tetrahydrodecyltriethoxysilane, manufactured by Gelest). Further, examples of the alkoxysilane having a polydimethylsiloxane unit in its molecule may include KPN-3504 (manufactured by Shin-Etsu Chemical Co., Ltd.), DMS-XE11 (ethoxy-terminal polydimethylsiloxane, manufactured by Gelest), DMS-XM11 (methoxy-terminal polydimethylsiloxane, manufactured by Gelest), and DMS-S12, -S14, -S15 (silanol-terminal polydimethylsiloxane).

The dry treatment is generally a method of uniformly dispersing a stock solution of alkoxysilane into a filler which is rotating at high speed by a stirrer. The dry treatment has difficulty in a uniform processing, but is widely used for an industrial use because large amount of fillers are able to be treated in a short time. When the treatment is performed on a dry filler, it is known that the processing efficiency may be increased if water is included in advance.

The wet treatment is generally a method of immersing a filler in a dilute solution of alkoxysilane. Since alkylsilanes, particularly, a long-chained alkylsilane, and fluoroalkylsilane are highly hydrophobic and it is difficult to perform the treatment in a water-alone system, it is appropriate to perform the treatment with a water-alcohol mixed solution which is pH-adjusted with acetic acid. Since the treatment is performed uniformly on the surface of the filler, the treatment may be performed with high accuracy.

Furthermore, it is also preferred to perform the dry treatment and the wet treatment substantially, and it is possible to manufacture particles having higher surface treatment rate, which cannot be achieved by only one treatment, or particles which are subjected to two different surface treatments.

Particularly, as for a surface treatment and a crushing and classification method for calcined silica, it is preferred to appropriately use a method described in [0055] to [0072] of Japanese Patent Laid-Open Publication No. 2008-137854.

Specific examples of the particles having an average primary particle diameter of 50 nm to 700 nm may include MEK-ST-L (average primary particle diameter 50 nm, silica sol manufactured by Nissan Chemical Industries, Ltd.), SEAHOSTAR KE-P10 (average primary particle diameter 150 nm, amorphous silica manufactured by NIPPON SHOKUBAI CO., LTD.), SEAHOSTAR KE-P30 (average primary particle diameter 300 nm, amorphous silica manufactured by NIPPON SHOKUBAI CO., LTD.), SEAHOSTAR KE-P50 (average primary particle diameter 550 nm, amorphous silica manufactured by NIPPON SHOKUBAI CO., LTD.), SEAHOSTAR KE-S30 (average primary particle diameter 300 nm, heat resistance 1000° C., calcined silica manufactured by NIPPON SHOKUBAI CO., LTD.), SEAHOSTAR KE-S50 (average primary particle diameter 500 nm, heat resistance 1000° C., calcined silica manufactured by NIPPON SHOKUBAI CO., LTD.), EPOSTAR S (average primary particle diameter 200 nm, melamine-formaldehyde condensate manufactured by NIPPON SHOKUBAI CO., LTD.), EPOSTAR MA-MX100W (average primary particle diameter 175 nm, poly methyl methacrylate (PMMA)-based crosslinked product manufactured by NIPPON SHOKUBAI CO., LTD.), EPOSTAR MA-MX200W (average primary particle diameter 350 nm, poly methyl methacrylate (PMMA)-based crosslinked product manufactured by NIPPON SHOKUBAI CO., LTD.), STAPHYROID (multilayered organic fine particle manufactured by Aica Kogyo Co., Ltd.), GANZPEARL (poly methyl methacrylate, polystyrene particle manufactured by Aica Kogyo Co., Ltd.).

The content of the particles is preferably 3% by mass to 50% by mass, more preferably 3% by mass to 40% by mass, and still more preferably 5% by mass to 20% by mass in the solid of the antireflective layer forming composition of the antireflective laminate of the present invention. If not less than the lower limit, large number of convex portions may be formed in the moth-eye structure. Therefore, the antireflectivity may be further enhanced. If not more than the upper limit, agglomeration hardly occurs in the antireflective layer forming composition. Therefore, it is easy to form the moth-eye structure.

It is preferred to contain only one kind of monodispersed silica particles having an average primary particle diameter of 50 nm to 200 nm and a Cv value less than 5% because the height of the unevenness of the moth-eye structure becomes uniform so that the reflectivity is further lowered. The Cv value is a value representing a polydispersity of the particle diameter, and is generally measured using a laser diffraction type particle diameter measuring apparatus, or in other particle diameter measurement manners. The Cv value may be calculated by obtaining a particle diameter distribution by an image analysis from a surface SEM image of the antireflective layer of the present invention. The Cv value is more preferably less than 3%.

(Binder Resin of Antireflective Layer)

The binder resin of the antireflective layer will be described.

The binder resin of the antireflective layer is preferably obtained by curing the binder resin forming compound (monomer).

A resin forming compound similar to the curable compound contained in the hard coat layer forming composition may be used. However, it is unnecessary to be the same as the binder in the hard coat layer, and various binders may be combined.

The content of the binder resin forming polymerizable compound is preferably 20% by mass to 95% by mass, more preferably 30% by mass to 85% by mass, and still more preferably 40% by mass to 75% by mass in the solid of the antireflective layer forming composition.

(Dispersant)

The antireflective layer may include a dispersant from the viewpoint of preventing agglomeration of the particles. The dispersant is not particularly limited, but is preferably an anionic compound such as sulfate and phosphate, a cationic compound such as an aliphatic amine salt and a quaternary ammonium salt, a nonionic compound, or a polymer compound, and more preferably a polymer compound because of high degree of freedom of selection for each of adsorptive groups and sterically repulsive groups. The dispersant may be commercially available. Examples thereof may include DISPERBYK 160, DISPERBYK 161, DISPERBYK 162, DISPERBYK 163, DISPERBYK 164, DISPERBYK 166, DISPERBYK 167, DISPERBYK 171, DISPERBYK 180, DISPERBYK 182, DISPERBYK 2000, DISPERBYK 2001, DISPERBYK 2164, Bykumen, BYK-P104, BYK-P104S, BYK-220S, Anti-Terra203, Anti-Terra204, and Anti-Terra205 (all trade names), manufactured by BYK-Chemie Japan K. K.

When the antireflective layer includes a dispersant, the content of the dispersant is preferably 0.01% by mass to 20% by mass, more preferably 0.05% by mass to 10% by mass, and still more preferably 0.1% by mass to 5% by mass based on the particle amount.

(Leveling Agent)

The antireflective layer may include a leveling agent.

Specific examples of the leveling agent may include conventionally known leveling agents such as fluorine-based or silicon-based leveling agents. The antireflective layer forming composition to which a leveling agent is added may impart a coating stability, slipperiness, antifouling property, and scratch resistance to the surface of the coating film during coating or drying.

In addition to the above-mentioned components, a polymerization initiator, an antistatic agent and the like may be further added appropriately to the antireflective layer forming composition.

[Plastic Substrate]

The antireflective laminate of the present invention may be formed on a substrate, or may be an antireflective laminate in which the hard coat layer is disposed at the substrate side. The substrate is not particularly limited. A glass substrate or a plastic substrate may be used, but a plastic substrate is preferred.

Various plastic substrate may be used, and examples thereof may include substrates containing a cellulose-based resin such as cellulose acylate (triacetate cellulose, diacetyl cellulose, acetate butyrate cellulose); a polyester resin such as polyethylene terephthalate; a (meth)acrylic resin, a polyurethane-based resin, polycarbonate, polystyrene, and olefin-based resin. From the viewpoint of easy manufacture of a permeation layer, a substrate containing cellulose acylate, polyethylene terephthalate, or a (meth)acrylic resin is preferred, a substrate containing cellulose acylate is more preferred, and a cellulose acylate film is still more preferred. As cellulose acylate, a substrate described in Japanese Patent Laid-Open Publication No. 2012-093723 may be preferably used.

The thickness of the plastic substrate is generally 10 μm to 1000 μm, but, is preferably 20 μM to 200 μm, and more preferably 25 μm to 100 μm from the viewpoint of good handlability, high transparency, and sufficient strength. As for the transparency of the plastic substrate, the transmittance is preferably 90% or more.

The antireflective laminate of the present invention preferably has an integral reflectivity of 3% or less, and more preferably 2% or less over the entire wavelength range of 380 nm to 780 nm.

The antireflective laminate of the present invention preferably has a haze value of 5% or less, and more preferably 3% or less.

[Method of Manufacturing Antireflective Laminate]

A method of manufacturing the antireflective laminate of the present invention includes,

coating a hard coat forming composition containing a binder resin forming compound and a solvent having a permeability to cellulose acylate on a cellulose acylate film to cause the binder resin forming compound to permeate into the cellulose acylate film and cure the binder resin forming compound, thereby forming a hard coat layer; and

coating an antireflective layer forming composition containing particles having an average primary particle diameter of 50 nm to 700 nm, a binder resin forming compound, and a solvent on the hard coat layer to cause a part of the binder resin forming compound to permeate into the hard coat layer such that the particles protrude, thereby forming a moth-eye structure by the particles on a surface opposite to the interface with the hard coat layer.

The binder resin forming compound in the antireflective layer forming composition is preferably a compound having a polymerizable group.

From the viewpoint of the permeability of the binder resin forming compound of the antireflective layer into the hard coat layer, the reaction rate of the polymerizable group of the compound having a polymerizable group is preferably 20% to 75%, more preferably 30% to 70%, and still more preferably 35% to 65% on the surface of the hard coat layer before the antireflective layer forming composition is coated.

Details of each component are as described above.

The coating method of the hard coat layer forming composition and the antireflective layer forming composition is not particularly limited, but any known method may be used. Examples thereof may include a dip coating method, an air knife coating method, a curtain coating method, a roller coating method, a wire bar coating method, a gravure coating method, and a die coating method.

[Polarizing Plate Protective Film]

The antireflective laminate (antireflective film) may be used as a surface protective film of the polarizing film (polarizing plate protective film).

Among two polarizer protective films, a film other than the antireflective film of the present invention is also preferably an optically-compensatory film having an optically-compensatory layer including an optically anisotropic layer. The optically-compensatory film (phase-difference film) may improve a viewing angle characteristic of a liquid display screen. Any known optically-compensatory film may be used, but, from the viewpoint of widening the viewing angle, the optically-compensatory film described in Japanese Patent Laid-Open Publication No. 2001-100042 is preferred.

Before lamination with the polarizer, the antireflective film of the present invention may be subjected to a saponification treatment. The saponification treatment is a treatment in which an optical film is immersed in a warm aqueous alkaline solution for a certain period of time, washed with water, and then washed with acid for neutralization. If a surface of a transparent support that adheres to the polarizing film is hydrophilized, since any treatment condition is available, a concentration of a treatment agent, a temperature of a treatment agent liquid, and a treatment time are appropriately determined. However, in general, the treatment conditions are decided so as to perform the treatment within 3 minutes for a need to ensure productivity. In general conditions, the alkali concentration is 3% by mass to 25% by mass, the treatment temperature is 30° C. to 70° C., and the treatment time is 15 seconds to 5 minutes. As the alkali species used in an alkali treatment, sodium hydroxide or potassium hydroxide is suitable. As the acid used in the acid-washing, sulfuric acid is suitable. As the water used in the water-washing, ion-exchange water or deionized water is suitable.

The surface of the plastic substrate opposite to that provided with the antireflective layer of the present invention is subjected to a saponification treatment, and boned to the polarizer using an aqueous polyvinyl alcohol solution.

Further, a UV-curable adhesive may be used in bonding the antireflective film of the present invention and the polarizer. It is preferred to provide a UV-curable adhesive layer on the surface of the plastic substrate opposite to that provided with the antireflective layer of the present invention. Specifically, it is preferred to bond to the polarizer using a certain UV-curable resin for the purpose of enhancing the productivity by a short time dry. For example, in Japanese Patent Laid-Open No. 2012-144690, the adherence, durability, and water resistance are enhanced by bonding to the polarizer through an adhesive layer containing three kinds, that is, 20% by mass to 60% by mass of a radical polymerizable compound having an SP value of 29 to 32, 10% by mass to 30% by mass of a radical polymerizable compound having an SP value of 18 to 21, and 20% by mass to 60% by mass of a radical polymerizable compound having an SP value of 21 to 23, in which each homopolymer has Tg of 60° C. or higher. In a case of using this adhesive layer, the antireflective film having the moth-eye structure of the present invention may or may not be subjected to a saponification treatment before bonding with the polarizer.

[Polarizing Plate]

The polarizing plate of the present invention is a polarizing plate having a polarizer and at least one protective film that protects the polarizer, and at least one sheet of the protective films is the antireflective film of the present invention. The polarizer may be sandwiched between the protective film and the phase difference film or may be a combination of the protective film and the polarizer.

The polarizer includes an iodine-based polarizing film, a dye-based polarizing film using dichroic dye, or a polyene-based polarizing film. The iodine-based polarizing film and the dye-based polarizing film may be generally manufactured using a polyvinyl alcohol-based film.

[Cover Glass]

The cover glass of the present invention includes the antireflective laminate of the present invention as a protective film.

[Image Display Device]

An image display device of the present invention includes the antireflective laminate or the polarizing plate of the present invention.

The antireflective film and the polarizing plate of the present invention may be suitably used in an image display device such as a liquid crystal display (LCD), a plasma display (PDP), an electroluminescence display (ELD), or a cathode ray tube display (CRT), and a liquid crystal display is particularly preferred.

In general, the liquid crystal display has a liquid crystal cell and two polarizing plates disposed at both sides thereof, and the liquid crystal cell carries liquid crystal between two electrode substrates. Further, one optically anisotropic layer may be disposed between the liquid cell and one of the polarizing plates, or two may be disposed between the liquid crystal cell and both of the polarizing plates. The liquid cell is preferably in a TN mode, a VA mode, an OCB mode, an IPS mode, or an ECB mode.

### Examples

The present invention will be described in more detail with reference to the following examples. Materials, reagents, amounts and ratios of substances, and operations described in the following examples may be appropriately changed without departing from the spirit of the present invention. Accordingly, the spirit of the present invention is not limited to the following examples.

[Manufacture of Antireflective Film]

A hard coat forming composition was prepared as described below, coated on the substrate, and cured to form a hard coat layer. Subsequently, an antireflective layer forming composition was prepare as described below and coated on the hard coat layer to manufacture an antireflective film.

(Preparation of Hard Coat Forming Composition)

Each component was added to give a composition of a hard coat forming composition A-1, which is shown in Table 1 below, and the obtained composition was introduced into a mixing tank, stirred, and filtered with a polypropylene filter having a pore size of 5 μm to prepare the hard coat forming composition A-1 (solid concentration of 45% by mass).

In the same manner as in the hard coat forming composition A-1, each component was mixed to have the composition shown in Table 1 below, and adjusted to be in the composition ratio (by mass) shown in Table 1, to prepare hard coat forming compositions A-2 to A-16.

In a solid, a monomer was 97% by mass and a polymerization initiator was 3% by mass. In addition, a mixing ratio of the solvents in Table 1 below is by mass ratio.

TABLE 1

| | | | | | | IR peak height | | |
|---|---|---|---|---|---|---|---|---|
| Hard coat | | | | | | on hard coat | | |
| forming | Solid | | | | | layer at interface | IR reflection | |
| com- | | Irg. | | Solid | | side with antireflective | reaction | Pencil |
| position | Monomer | 184 | Solvent | concentration | Substrate | layer (903 cm⁻¹) | ratio (%) *1 | hardness *2 |
| A-1 | A-TMMT (97%) | 3% | MIBK/MEK/methyl | 45% | TD80 | Below detection limit | 20% | 2H |
| | | | acetate = 75/15/10 | | | | | |
| A-2 | A-TMMT (97%) | 3% | MIBK/MEK/methyl | 45% | TD80 | Below detection limit | 34% | 2H |
| | | | acetate = 75/15/10 | | | | | |
| A-3 | A-TMMT (97%) | 3% | MIBK/MEK/methyl | 45% | TD80 | Below detection limit | 41% | 2H |
| | | | acetate = 75/15/10 | | | | | |
| A-4 | A-TMMT (97%) | 3% | MIBK/MEK/methyl | 45% | TD80 | Below detection limit | 32% | 2H |
| | | | acetate = 17/66/17 | | | | | |
| A-5 | A-TMMT (97%) | 3% | MIBK/MEK/methyl | 45% | TD80 | Below detection limit | 36% | 2H |
| | | | acetate = 17/66/17 | | | | | |
| A-6 | A-TMMT (97%) | 3% | MEK/methyl acetate = 50/50 | 35% | TD80 | 0.003 | 24% | 2H |
| A-7 | A-TMMT (97%) | 3% | MEK/methyl acetate = 50/50 | 35% | TD80 | 0.003 | 42% | 2H |
| A-8 | A-TMMT (97%) | 3% | MEK/methyl acetate = 50/50 | 35% | TD80 | 0.007 | 52% | 2H |
| A-9 | A-TMMT (97%) | 3% | MEK/methyl acetate = 50/50 | 35% | TD80 | 0.006 | 67% | 2H |
| A-10 | A-TMMT (97%) | 3% | MEK/methyl acetate = 50/50 | 35% | TD80 | 0.005 | 72% | 2H |
| A-11 | A-TMMT (97%) | 3% | MEK/methyl acetate = 50/50 | 35% | TD80 | 0.005 | 84% | 2H |
| A-12 | A-TMMT (97%) | 3% | MEK/methyl acetate = 50/50 | 35% | TG60UL | 0.006 | 48% | 2H |
| A-13 | PET30 (97%) | 3% | MEK/methyl acetate = 50/50 | 35% | TD80 | 0.006 | 40% | 2H |
| A-14 | PET30 (97%) | 3% | MEK/methyl acetate = 50/50 | 35% | TD80 | 0.007 | 51% | 2H |
| A-15 | PET30 (97%) | 3% | MEK/methyl acetate = 50/50 | 35% | TD80 | 0.007 | 62% | 2H |
| A-16 | A-TMPT (97%) | 3% | MEK/methyl acetate = 50/50 | 35% | TD80 | 0.006 | 60% | 2H |
| — | — | — | — | — | TD80 | 0.011 *3 | — | 2B |
| — | — | — | — | — | TG60UL | 0.011 *3 | — | 2B |

*1: the reaction ratio was adjusted by changing a UV ray dose and a drying condition before irradiation with UV ray.
*2: the pencil hardness in the table was measured for a cured degree of a fully-cured hard coat obtained by additionally irradiating a half-cured one with a UV ray of 300 mJ/cm²
*3: IR peak height of TD80 surface and TG60UL.

In the same manner as in the hard coat forming composition A-1, each component was mixed to have the composition shown in Table 2 below, and adjusted to be in the composition ratio (by mass) shown in Table 2, to prepare the hard coat forming compositions A-17 to A-23. Meanwhile, the above-mentioned A-8 is also described in Table 2 for comparison.

TABLE 2

| | Solid | | | | | | | IR peak height | | |
|---|---|---|---|---|---|---|---|---|---|---|
| | | additive having | | | | | | on hard coat layer | | |
| Hard coat | | a hydroxyl | | | | | | at interface side | IR reflection | |
| forming | | group-reactive | | | | Solid | | with antireflective | reaction ratio | Pencil |
| composition | Monomer | moiety | Irg. 184 | Irg. 290 | Solvent | conc. | Substrate | layer (903 cm⁻¹) | (%) *1 | hardness *2 |
| A-8 | A-TMMT | — | 3% | — | MEK/methyl | 35% | TD80 | 0.007 | 52% | 2H |
| | (97%) | | | | acetate = 50/50 | | | | | |
| A-17 | A-TMMT | BL4265 (9%) | 3% | — | MEK/methyl | 35% | TD80 | 0.007 | 45% | 2H |
| | (88%) | | | | acetate = 50/50 | | | | | |
| A-18 | A-TMMT | BL4265 (9%) | 3% | — | MEK/methyl | 35% | TD80 | 0.005 | 84% | 2H |
| | (88%) | | | | acetate = 50/50 | | | | | |
| A-19 | A-TMMT | BL4265 (9%) | 3% | — | MEK/methyl | 35% | TG60UL | 0.005 | 60% | 2H |
| | (88%) | | | | acetate = 50/50 | | | | | |
| A-20 | PET30 | BL4265 (9%) | 3% | — | MEK/methyl | 35% | TD80 | 0.007 | 62% | 2H |
| | (88%) | | | | acetate = 50/50 | | | | | |
| A-21 | A-TMPT | BL4265 (9%) | 3% | — | MEK/methyl | 35% | TD80 | 0.006 | 60% | 2H |
| | (88%) | | | | acetate = 50/50 | | | | | |
| A-22 | A-TMMT | VPLS2078-2 (9%) | 3% | — | MEK/methyl | 35% | TD80 | 0.007 | 55% | 2H |
| | (88%) | | | | acetate = 50/50 | | | | | |
| A-23 | A-TMMT | Cyclomer M100 | 3% | 2% | MEK/methyl | 35% | TD80 | 0.006 | 51% | 2H |
| | (86%) | (9%) | | | acetate = 50/50 | | | | | |
| — | — | | — | — | — | — | TD80 | 0.011 *3 | — | 2B |
| — | — | | — | — | — | — | TG60UL | 0.011 *3 | — | 2B |

*1: the reaction ratio was adjusted by changing a UV ray dose and a drying condition before irradiation with UV ray.
*2: the pencil hardness in the table was measured for a cured degree of a fully-cured hard coat obtained by additionally irradiating a half-cured one with a UV ray of 300 mJ/cm²
*3: IR peak height of TD80 surface and TG60UL.

The IR peak height on the hard coat layer at the interface side with the antireflective layer was measured once with ATR-IR reflectometry technique using NICOLET6700 FT-IR manufactured by Thermo Electron Corporation with scanning 32 times, to calculate a peak height around 903 cm⁻¹, which is the peak derived from glucose contained in cellulose acylate. Where peak does not appear is recorded as “below detection limit.”

As shown in Table 1, the antireflective film sample Nos. A-1 to A-5 have “IR peak height at the interface side with the antireflective layer” below the detection limit, and the hard coat layer of the films thereof, which do not include cellulose acylate in a region with a 1 μm thickness from the interface with the antireflective layer in a film thickness direction.

PET30: mixture of pentaerythritol tetraacrylate and pentaerythritol triacrylate (manufactured by Nippon Kayaku Co., Ltd.)

A-TMMT: pentaerythritol tetraacrylate (manufactured by Shin-Nakamura Chemical Co., Ltd.)

A-TMPT: trimethylolpropane triacrylate (manufactured by Shin-Nakamura Chemical Co., Ltd.)

Irg. 184: photopolymerization initiator, Irgacure 184 (manufactured by BASF Japan Ltd.)

Irg. 290: cationic polymerization initiator, Irgacure 290 (manufactured by BASF Japan Ltd.)

MEK: methyl ethyl ketone

MIBK; methyl isobutyl ketone

TD80: cellulose acylate film having a film thickness of 80 μm (manufactured by Fujifilm Corporation)

TG60UL: cellulose acylate film having a film thickness of 60 μm (manufactured by Fujifilm Corporation)

A component used as an additive having a hydroxyl group-reactive moiety is as follows.

BL4265: Desmodur BL4265, manufactured by Sumitomo Bayer Urethane Co., Ltd., a compound having the following structure.

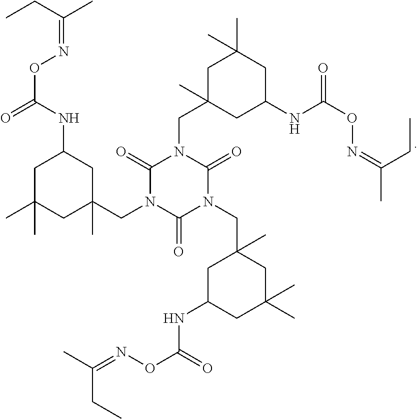 [SMILES: CC/C(C)=N\OC(=O)NC1CC(C)(C)CC(C)(Cn2c(=O)n(CC3(C)CC(NC(=O)O/N=C(/C)CC)CC(C)(C)C3)c(=O)n(CC3(C)CC(NC(=O)O/N=C(/C)CC)CC(C)(C)C3)c2=O)C1]

VPLS2078-2: Desmodur VP LS 2078/2, manufactured by Sumitomo Bayer Urethane Co., Ltd., a compound having the following structure.

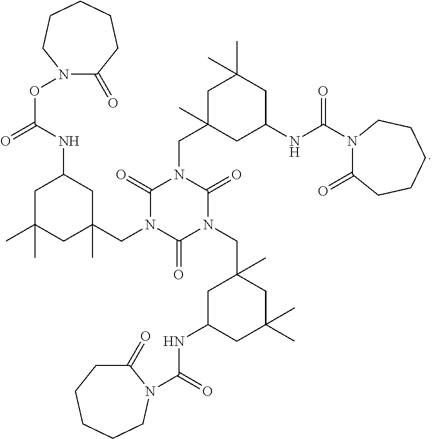 [SMILES: CC1(C)CC(NC(=O)ON2CCCCCC2=O)CC(C)(Cn2c(=O)n(CC3(C)CC(NC(=O)N4CCCCCC4=O)CC(C)(C)C3)c(=O)n(CC3(C)CC(NC(=O)N4CCCCCC4=O)CC(C)(C)C3)c2=O)C1]

CYCLOMER M100: manufactured by Daicel Corporation, a compound having the following structure.

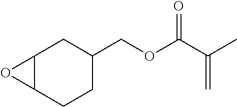

(Preparation of Antireflective Layer Forming Composition)

Each component was added to give composition shown in Table 3, and the obtained composition was introduced into a mixing tank, stirred, and filtered with a polypropylene filter having a pore size of 5 μm to prepare an antireflective layer forming composition B (liquid B) and an antireflective layer forming composition D (liquid D).

TABLE 3

| | Mixing amount (g) | Mixing amount (g) |
|---|---|---|
| | of liquid B | of liquid D |
| (A) Particles | 87 | — |
| (B) Binder forming material | 295 | 382 |
| (C) Silane coupling agent | 15 | 15 |
| Irg. 127 | 13 | 13 |
| M1245 | 3 | 3 |
| Methyl ethyl ketone | 239 | 239 |

In Tables 3 and 4, (A) particles are the following silane coupling agent-treated silica particles A3.

(B) Binder forming material includes PET30, DPHA, and the following C in a ratio of 90:5:5 (mass ratio).

(C) Silane coupling agent is the following C.

[Synthesis of Silica Particles A1]

Into a reactor having a capacity of 200 L with a stirrer, a dropping device, and a thermometer, 67.54 kg of methyl alcohol and 26.33 kg of 28% by mass ammonia water (water and a catalyst) were introduced, and the liquid temperature was adjusted to 33° C. with stirring. Meanwhile, a solution of 12.70 kg of tetramethoxysilane dissolved in 5.59 kg of methyl alcohol was introduced into the dropping device. The solution was added dropwise from the dropping device over 1 hour while maintaining the liquid temperature in the reactor at 33° C., and, after the dropwise addition was completed, stirring was further carried out for 1 hour while maintaining the liquid temperature to that temperature and the tetramethoxysilane was subjected to hydrolysis and condensation to obtain a dispersion containing silica particles precursor. The dispersion was subjected to flash drying using an instantaneous vacuum evaporator (Crux system CVX-8B type manufactured by HOSOKAWA MICRON CORPORATION) under conditions of a heating pipe temperature of 175° C. and a reduced pressure of 200 torr (27 kPa) to obtain silica particles A1. The average particle diameter was 200 nm, and the polydispersity of the particle diameter (Cv value) was 3.5%.

[Preparation of Calcined Silica Particles A2]

Into a crucible, 5 kg of silica particles A1 was introduced, calcined using an electric furnace at 1,050° C. for 1 hour, cooled, and then, pulverized using a pulverizer to obtain non-classified calcined silica particles. Further, crush and classification were performed using a jet milling classifier (IDS-2 type manufactured by Nippon Pneumatic Mfg. Co., Ltd.) to obtain calcined silica particles A2. The average diameter of the obtained silica particles was 0.20 μm, and the polydispersity of the particle diameter (Cv value) was 3.5%.

[Preparation of Silane Coupling Agent-Treated Silica Particles A3]

Into a Henschel mixer (FM20J type manufactured by Mitsui Mining Co. Ltd.) having a capacity of 20 L with a heating jacket, 5 kg of non-classified calcined silica particles A2 were introduced. Into the place wherein the calcined silica particles A2 are being stirred, a solution, in which 45 g of KBM-5103 is dissolved in 90 g of methyl alcohol, was added dropwise and mixed. Subsequently, the mixture was heated to 150° C. over 1 hour while mixing and stirring, and subjected to heat treatment while maintaining at 150° C. for 12 hours. In the heat treatment, wall deposits were scraped by a scraping apparatus rotating in a direction opposite to a stirring blade. In addition, appropriately, the wall deposits were scraped by using a spatula. After heating, the mixture was cooled, and crush and classification were performed using a jet milling classifier to obtain silane coupling agent processed silica particles A3. The average particle diameter was 0.21 μm, and the polydispersity of the particle diameter (Cv value) was 3.7%.

KBM-5103 Manufactured by Shin-Etsu Chemical Co., Ltd.

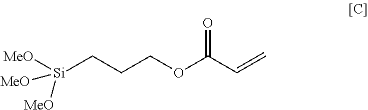

Into a flask equipped with a reflux condenser and a thermometer, 19.3 g of KBE-9007 (manufactured by Shin-Etsu Chemical Co., Ltd.) and 3.9 g of glycerol 1,3-bis acrylate, 6.8 g of 2-hydroxyethyl acrylate, 0.1 g of dibutyltin dilaurate, and 70.0 g of toluene were introduced, and stirred over 12 hours at room temperature. After stirring, 500 ppm of methylhydroquinone was added and distilled off under reduced pressure to obtain C.

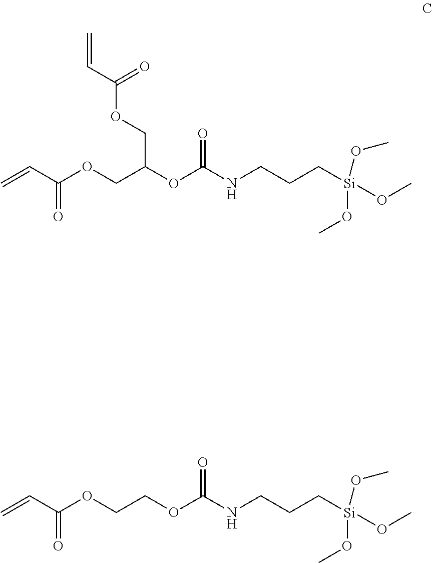

PET 30: a mixture of pentaerythritol tetraacrylate and pentaerythritol triacrylate (manufactured by Nippon Kayaku Co., Ltd.)

DPHA: a mixture of dipentaerythritol pentaacrylate and dipentaerythritol hexaacrylate (manufactured by Nippon Kayaku Co., Ltd.)

Irg. 127: photopolymerization initiator, Irgacure 127 (manufactured by BASF Japan Ltd.)

M1245: 2-(4-methoxyphenyl)-4,6-bis(trichloromethyl)-1,3,5-triazine (manufactured by Tokyo Chemical Industry Co., Ltd.)

(Manufacture of Antireflective Film)

The hard coat layer forming composition was coated on each substrate listed in Table 1 using a gravure coater. UV ray dose and drying condition before UV ray irradiation were appropriately adjusted to have a reaction ratio (half-cured state) as listed in “IR reflection reaction ratio *1” of Table 1. The UV ray was irradiated at illuminance of 20 mW/cm² by using an air-cooled metal halide lamp (240 W/cm) (manufactured by Eye Graphics Co., Ltd.), while purging with nitrogen to be an atmosphere having an oxygen concentration of 0.9% to 1.3%.

The film thickness of the hard coat layer was set to 12 μm.

In Table 1, “IR reflection reaction ratio *1” was calculated by performing a KBr-IR measurement on a polymerizable compound (monomer) itself before reaction, calculating a peak area of a carbonyl group (1,660 to 1,800 cm⁻¹) and a peak height (808 cm⁻¹) of a double bond, calculating a peak of a double bond with respect to the peak area of the carbonyl group from an IR measurement of a single reflection after the half cure in the same manner, and making a comparison before and after the UV irradiation. Here, when the reaction rate was calculated, normalization was carried out by setting a measurement depth at 808 cm⁻¹ to 821 nm, and setting a depth at 1,660 to 1,800 cm⁻¹ to 384 nm.

Meanwhile, “Pencil hardness *2” in Table 1 was evaluated after each sample in the half-cured state was further cured by irradiation with UV ray (300 mJ/cm²). The pencil hardness evaluation was performed on a surface of a hard coat after additional irradiation. Then, the pencil mark was removed by an eraser.

After the sample was subjected to moisture-conditioning at a temperature of 25° C. and a relative humidity of 60% for 2 hours, the pencil hardness evaluation was performed in accordance with the pencil hardness evaluation method prescribed in JIS-K5400, using a test pencil prescribed in JIS-S6006.

Subsequently, the antireflective layer forming composition was coated on the above-mentioned hard coat layer in the half cured state using gravure coater. After drying at 150° C. for 5 minutes, a cover layer was cured by irradiation with UV ray at illuminance of 60 mW/cm² and a dose of 300 mJ/cm² by an air-cooled metal halide lamp (manufactured by Eye Graphics Co., Ltd.) while purging with nitrogen to be an atmosphere having an oxygen concentration of 0.1 vol % or less, thereby forming an antireflective layer to manufacture antireflective film sample Nos. 1A to 16A. Meanwhile, the film thickness was set to 0.6 μm when coated and cured on a glass in the same manner.

Antireflective film samples Nos. 17A to 23A were manufactured in the same manner, except that the samples Nos. 17 to 23 were used as hard coat layer forming compositions.

In addition, a surface film peeled off from a television of AQUOS “LC-46 XL9”, manufactured by Sharp Corporation, was used as a comparison film (sample No. 24A).

(Evaluation of Antireflective Film)

The antireflective film was evaluated by the following methods. The results are listed in Table 3.

(Confirmation of Moth-Eye Structure)

A surface shape was evaluated by observing the surface of the antireflective film with a scanning electron microscope. A period of a microstructured pattern was calculated by drawing a random straight line on a scanning electron microscope photograph from end to end, using an average value of a distance measured (n=50) between apexes of the adjacent convex portions on the straight line, and rounding off 1 digit (less than 10 nm). In a case where convex portions are not observable, it was concluded in “no period”.

A: Shape formed of curved convex portions with a clear moth-eye structure

B: There is non-uniformity in a period of convex portions, which may be classified as a moth-eye structure, or a height of the particles exposed to an air layer is less than ¼ of the particle diameter (binder film thickness greater or equal to 157.5 nm in a case of A3 particles)

C: Other shape without convex portions (no period).

(Film Thickness of Binder Resin of Film Thickness Moth-Eye Layer)

The antireflective film sample was cut by a microtome to expose its cross-section, which was observed with a scanning electron microscope (SEM), so that the film thickness was calculated by subtracting a height of the particles exposed in an air layer from the particle diameter.

(Integral Reflectivity)

In a state where the rear surface of the antireflective film (the front surface of the substrate) was subjected to a roughening with a sand paper and then treated with a black ink to eliminate rear surface reflection, the integral reflectivity was measured at an incidence angle of 5° in a wavelength region of 380 nm to 780 nm using a spectrophotometer V-550 (manufactured by JASCO Corporation) equipped with an adaptor ARV-474, and the average reflectivity was calculated, thereby evaluating the antireflection.

(Surface Uniformity)

Surface defects such as lining on a surface of a hard coat layer after half cure, or extraneous materials after coating the antireflective layer, was confirmed by visual observation.

A: No particularly observable surface defect

B: Slight lining or extraneous materials (NG level)

C: Unmeasurable due to a large amount of extraneous materials or scratches after coating the antireflective layer

(Pencil Hardness)

After the sample was subjected to moisture-conditioning at a temperature of 25° C. and a relative humidity of 60% for 2 hours, the pencil hardness test was performed in accordance with pencil hardness evaluation method prescribed in JIS K 5600-5-4(1999), using a test pencil prescribed in JIS S 6006(2007).

(Evaluation of Steel Wool Scratch Resistance)

A rubbing test was performed using a rubbing tester under the following conditions to make a scratch resistance index.

Evaluation environment condition: 25° C., 60% RH

Rubbing material: coiled around a rubbing front end (1 cm×1 cm) of the tester that comes in contact with a steel wool sample (manufactured by Nihon Steel Wool Co., Ltd., grade No. 0000)

Displacement (one way): 13 cm

Rubbing speed: 13 cm/sec

Load: 200 g/cm²

Front end contact area: 1 cm×1 cm

Number of times rubbed: 10 reciprocating motion

The rear surface of the rubbed sample was painted with a black ink and visual observation was made with reflected lights on scratch in the rubbed portion to evaluate scratch on the rubbed surface.

A: No scratch is observed after careful observation

B: Slight scratch is observed after careful observation

C: Small scratch is observed

D: Medium-sized scratch is observed

E: Easily noticeable scratch is observed

TABLE 4

| | | | Evaluation | | | | |
|---|---|---|---|---|---|---|---|
| | Hard coat | | Film thickness | Surface shape | | | |
| Sample | layer forming | Antireflective layer | Film thickness of binder resin in | Moth-eye | Surface | Integral | |
| No. | composition | forming composition | antireflective layer [nm] | structure | uniformity | reflectivity | |
| No. 1A | A-1 | B | 80 | A | C | — | Comp. Ex. |
| No. 2A | A-2 | B | 180 | C | A | 3.7% | Comp. Ex. |
| No. 3A | A-3 | B | 200 | C | A | 4.0% | Comp. Ex. |
| No. 4A | A-4 | B | 165 | B | B | 2.6% | Comp. Ex. |
| No. 5A | A-5 | B | 260 | C | A | 4.6% | Comp. Ex. |
| No. 6A | A-6 | B | 121 | A | A | 1.7% | Ex. |
| No. 7A | A-7 | B | 105 | A | A | 1.4% | Ex. |
| No. 8A | A-8 | B | 89 | A | A | 1.3% | Ex. |
| No. 9A | A-9 | B | 121 | A | A | 1.5% | Ex. |
| No. 10A | A-10 | B | 163 | B | A | 2.3% | Ex. |
| No. 11A | A-11 | B | 280 | C | A | 4.3% | Comp. Ex. |
| No. 12A | A-12 | B | 121 | A | A | 1.8% | Ex. |
| No. 13A | A-13 | B | 90 | A | A | 1.6% | Ex. |
| No. 14A | A-14 | B | 120 | A | A | 1.8% | Ex. |
| No. 15A | A-15 | B | 130 | A | A | 1.7% | Ex. |
| No. 16A | A-16 | B | 80 | A | A | 1.4% | Ex. |

TABLE 5

Evaluation

| | | | Film thickness | Surface | | | | | |
|---|---|---|---|---|---|---|---|---|---|
| | Hard coat | | Film thickness of binder | shape | | | | | |
| | layer forming | Antireflective layer | resin in antireflective | Moth-eye | Surface | Integral | Pencil | SW test | |
| Sample. No. | composition | forming composition | layer [nm] | structure | uniformity | reflectivity | hardness | 200 g | |
| No. 8A | A-8 | B | 89 | A | A | 1.3% | 2H | B | Ex. |
| No. 17A | A-17 | B | 91 | A | A | 1.3% | 2H | A | Ex. |
| No. 18A | A-18 | B | 280 | C | A | 4.3% | 2H | A | Comp. Ex. |
| No. 19A | A-19 | B | 115 | A | A | 1.6% | 2H | A | Ex. |
| No. 20A | A-20 | B | 130 | A | A | 1.7% | 2H | A | Ex. |
| No. 21A | A-21 | B | 95 | A | A | 1.4% | 2H | A | Ex. |
| No. 22A | A-22 | B | 100 | A | A | 1.5% | 2H | A | Ex. |
| No. 23A | A-23 | B | 105 | A | A | 1.5% | 2H | A | Ex. |
| No. 24A | | | | A | A | 0.6% | F | E | Comp. Ex. |

As seen from Table 4 and Table 5, each sample of Examples of the present invention has the moth-eye structure on the antireflective layer, thereby having low integral reflectivity and excellent surface uniformity.

In addition, from Table 5, in a case where an additive having a hydroxyl group-reactive moiety is contained in the hard coat forming composition, a hydroxyl group remaining in cellulose acylate reacts with the above-mentioned additive and forms a crosslinked structure. Therefore, elution of the cellulose acylate may be suppresses, thereby enhancing the scratch resistance.

Meanwhile, in order to confirm that the cellulose acylate was not eluted onto the antireflective layer, an experiment using the antireflective layer forming composition D, which does not include particles, was performed (because there is a case where TOF-SIMS measurement is not accurately made if the particles exist).

Samples Nos. 25 to 32 were prepared in the manner as in Examples Nos. 1 to 23, except that the antireflective forming composition D, which does not include particles, was coated on the surfaces of the hard coat layers formed by the hard coat forming compositions A-8 and A-17 to 23.

Presence of the cellulose acylate on the surface of the antireflective layer after coating was confirmed by Time of Flight-Secondary Ion Mass Spectrometry (TOF-SIMS). The measurement of TOF-SIMS may be performed using, for example, TOF-SIMS type TRIFRII (manufactured by Phi Evans Co.) by detecting a fragment resulting from the cellulose acrylates present on the film surface. TOF-SIMS method is described in detail in “Secondary Ion Mass Spectrometry”, Selected Book on Surface Analysis Technology, edited by The Surface Science Society of Japan, published by Maruzen Co., Ltd., (1990).

TABLE 6

| | | | Evaluation *5 |
|---|---|---|---|
| | Hard coat | Antireflective | Presence of peak |
| | layer forming | layer forming | derived from cellulose |
| Sample No. | composition | composition | acylate of surface layer |
| No. 25A | A-8 | D | Present |
| No. 26A | A-17 | D | Below detection limit |
| No. 27A | A-18 | D | Below detection limit |
| No. 28A | A-19 | D | Below detection limit |
| No. 29A | A-20 | D | Below detection limit |
| No. 30A | A-21 | D | Below detection limit |
| No. 31A | A-22 | D | Below detection limit |
| No. 32A | A-23 | D | Below detection limit |

*5: Confirmation whether a fragment derived from tack was made by TOF-SIMS.

As seen from Table 6, it was confirmed that, in the sample having a product formed by reacting a hydroxyl group contained the cellulose acylate and the additive on the hard coat layer, the cellulose acylate was not eluted onto the antireflective layer.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An antireflective laminate comprising:
a hard coat layer; and
an antireflective layer adjacent to the hard coat layer,
wherein the hard coat layer includes cellulose acylate in a region with 1 μm thickness from an interface with the antireflective layer in a film thickness direction, and
the antireflective layer includes a binder resin and particles having an average primary particle diameter of 50 nm or more and 700 nm or less, and has a moth-eye structure by the particles on a surface opposite to the interface with the hard coat layer.

2. The antireflective laminate according to claim 1,
wherein the hard coat layer includes a cured product of a polyfunctional monomer containing three or more (meth)acryloyl groups in one molecule.

3. The antireflective laminate according to claim 1,
wherein the hard coat layer includes a product formed by reacting an additive having a hydroxyl group-reactive moiety and a hydroxyl group contained in the cellulose acylate.

4. The antireflective laminate according to claim 3,
wherein the additive is an additive having two or more hydroxyl group-reactive moieties, or an additive having one or more hydroxyl group-reactive moieties and a polymerizable group-reactive moiety.

5. An antireflective laminate comprising, on a substrate, the antireflective laminate according to claim 1,
wherein the hard coat layer is provided at a substrate side than the antireflective laminate.

6. The antireflective laminate according to claim 5,
wherein the substrate is a plastic substrate.

7. The antireflective laminate according to claim 6,
wherein the plastic substrate is a cellulose acylate film.

8. A method of manufacturing the antireflective laminate, comprising:
coating, on a cellulose acylate film, a hard coat forming composition containing a binder resin forming compound and a solvent having a permeability to cellulose acylate to cause the binder resin forming compound to permeate into the cellulose acylate film;
curing the binder resin forming compound to form a hard coat layer; and
coating, on the hard coat layer, an antireflective layer forming composition containing particles having an average primary particle diameter of 50 nm to 700 nm, a binder resin forming compound, and a solvent so that a part of the binder resin forming compound is permeated into the hard coat layer to protrude the particles and form a moth-eye structure due to the particles on a surface opposite to an interface with the hard coat layer.

9. The method according to claim 8,
wherein the binder resin forming compound is a compound having a polymerizable group, and
a reaction ratio of the polymerizable group of the compound having the polymerizable group is 20% to 75% at the surface of the hard coat layer before the antireflective layer forming composition is coated.

10. A polarizing plate comprising the antireflective laminate according to claim 1.

11. A cover glass comprising the antireflective laminate according to claim 1.

12. An image display device comprising the antireflective laminate according to claim 1.

13. An image display device comprising the cover glass according to claim 10.
